(19) United States
(12) Patent Application Publication
(10) Pub. No.: US 2004/0236565 A1
(43) Pub. Date: Nov. 25, 2004

(54) System and method for playing vocabulary explanations using multimedia data

(76) Inventors: Saying Wen, Taipei (TW); Bill Tseng, Taipei (TW); H. Y. Chen, Taipei (TW); Spring Liou, Xian (CN); Great W.H. HE, Xian (CN)

Correspondence Address: HARNESS, DICKEY & PIERCE, P.L.C., P.O. BOX 8910, RESTON, VA, 20195, US

(21) Appl. No.: 10/419,847

(22) Filed: Apr. 22, 2003

(51) Int. Cl. G06F 17/28

(52) U.S. Cl. 704/3

(57) ABSTRACT

Through an electronic dictionary, a system and method for playing vocabulary explanations using multimedia data provides texts, pictures, sounds, animations, music, and videos for explaining words. The electronic dictionary has an input unit, a database, a display unit, a central processing unit (CPU), and a multimedia player. The database further stores keyword index data and keyword explanation data. The keyword explanation data include texts, pictures, sounds, animations, music and videos. By looking up the dictionary, the user can obtain thorough information via the multimedia word explanations and be able to learn more efficiently about the language.

### BACKGROUND OF THE INVENTION

1. Field of Invention

The invention relates to a system and method for playing vocabulary explanations using multimedia data and, in particular, to a system and method that provide texts, pictures, sounds, animations, music, and videos for word explanations on an electronic dictionary.

2. Related Art

After the invention of electronic dictionary, it has been a convenient and useful tool for learning a language. However, from the electronic dictionaries on the market, we can see that most of them have merely text explanations. It requires users to comprehend the true meanings of the text explanations using their own wisdom and experience. Some advanced electronic dictionaries add the functions of playing pictures and sounds. However, sometimes the pictures and sounds cannot really help users understand the meanings and uses of a word/phrase in the fastest and most correct manner.

The acquisition of knowledge is mainly built upon comprehension and memorization. Electronic dictionaries with explanation only in texts, pictures or sounds are still far from enabling users to quickly and correctly understand words. Therefore, it is of great consequence to find a way that can enable users to learn and remember things quickly.

### SUMMARY OF THE INVENTION

In view of the foregoing, an objective of the invention is to provide a system and method for playing vocabulary explanations using multimedia data. With the continuous advances in multimedia technologies, it is already possible to make a multimedia electronic dictionary.

Consequently, a primary objective of the invention is to provide an electronic dictionary, which can show the sound, spelling, and meaning of a keyword and related multimedia of texts, pictures, sounds, animations, music and videos. It helps users to quickly comprehend and memorize the word, achieving the goal of quick language learning.

Pursuant to the above objective, the disclosed system contains an input unit, a database, a display unit, a central processing unit (CPU), and a multimedia player. The input unit enables the keyword input. The database stores text explanations, multimedia explanation index, and multimedia explanations. The CPU is connected to the input unit and the database. It is in charge of the inquiry command for the keyword entered via the input unit. It provides text explanations and multimedia explanations according to the multimedia explanation index information. The multimedia player is connected to the CPU for playing the multimedia explanations. The display unit is connected to the CPU for displaying text and multimedia explanations.

The user enters a keyword to look up via the input unit. The CPU processes to look up the keyword in the database for its explanations. The explanation information is displayed on the display unit. If the related explanation information contains multimedia explanations, the user can select to play the multimedia explanation information.

### BRIEF DESCRIPTION OF THE DRAWINGS

The invention will become more fully understood from the detailed description given hereinbelow illustration only, and thus are not limitative of the present invention, and wherein:

FIG. 1 shows the system structure of the invention;

FIG. 2 is a flowchart of the disclosed multimedia explanation playing procedure;

FIG. 3 is a diagram of the word and phrase index according to an embodiment of the invention;

FIG. 4 is a diagram showing the word meaning in an embodiment of the invention;

FIG. 5 is a first screen shot of the multimedia explanation according to an embodiment of the invention;

FIG. 6 is a second screen shot of the multimedia explanation according to an embodiment of the invention;

FIG. 7 is a third screen shot of the multimedia explanation according to an embodiment of the invention; and

FIG. 8 is a fourth screen shot of the multimedia explanation according to an embodiment of the invention.

### DETAILED DESCRIPTION OF THE INVENTION

The invention relates to a system and method for playing vocabulary explanations using multimedia data. Through an electronic dictionary, the invention provides multimedia vocabulary explanations in terms of texts, pictures, sounds, animations, music, and videos. The electronic dictionary contains an input unit, a database, a display unit, a CPU, and a multimedia player. The database stores keyword index data and keyword explanation data. The keyword explanation data further contain multimedia explanation information in texts, pictures, sounds, animations, music, and videos. Looking up a word in the electronic dictionary, the user can obtain a deep impression about the word from the playing of multimedia explanations. Therefore, the invention is able to achieve the goal of quick learning.

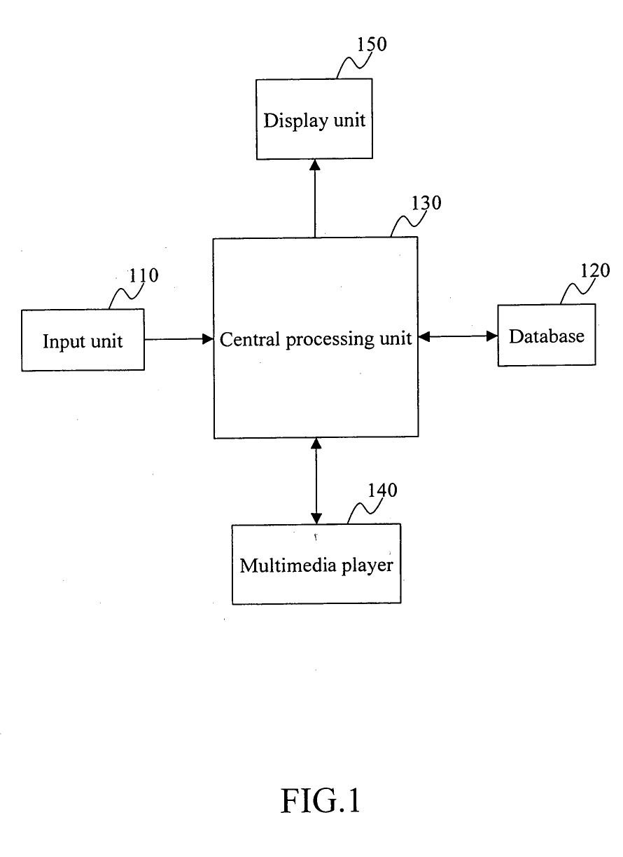

With reference to FIG. 1, the basic structure of the disclosed system is comprised of an input unit 110, a database 120, a CPU 130, a multimedia player 140, and a display unit 150.

The input unit 110 enables the keyword input. The database 120 stores text explanations, multimedia explanation index, and multimedia explanations. The CPU 130 is connected to the input unit 110 and the database 120. It is in charge of the inquiry command for the keyword entered via the input unit 10. It provides text explanations and multimedia explanations according to the multimedia explanation index information. The multimedia player 140 is connected to the CPU 130 for playing the multimedia explanations. The display unit 150 is connected to the CPU 130 for displaying text and multimedia explanations.

The above-mentioned keyword may be a single word, a phrase, or even a sentence. The text explanations include information of the word meanings, related words, example sentences, grammatical information, and usage information. The multimedia explanations consist of the combinations of text information, picture information, sound information, music information, animation information and video information. The playing of the sound information, music information, animation information and video information is triggered by pressing a multimedia explanation playing button on a touch-control screen or a keyboard. The multimedia player 140 then reads and displays the information via the display unit 150.

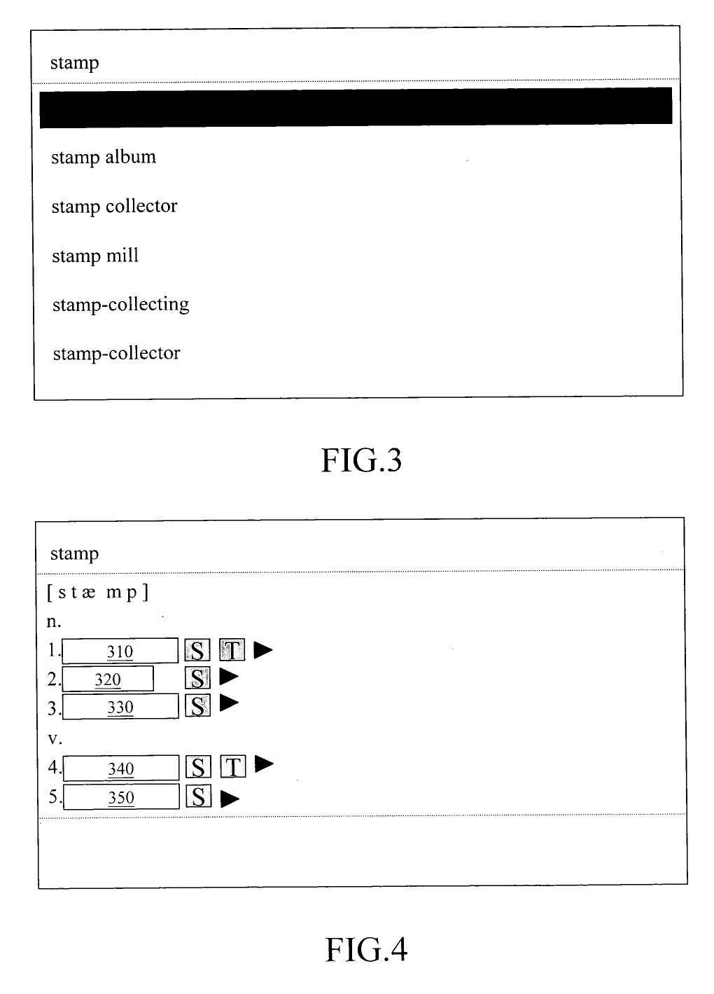

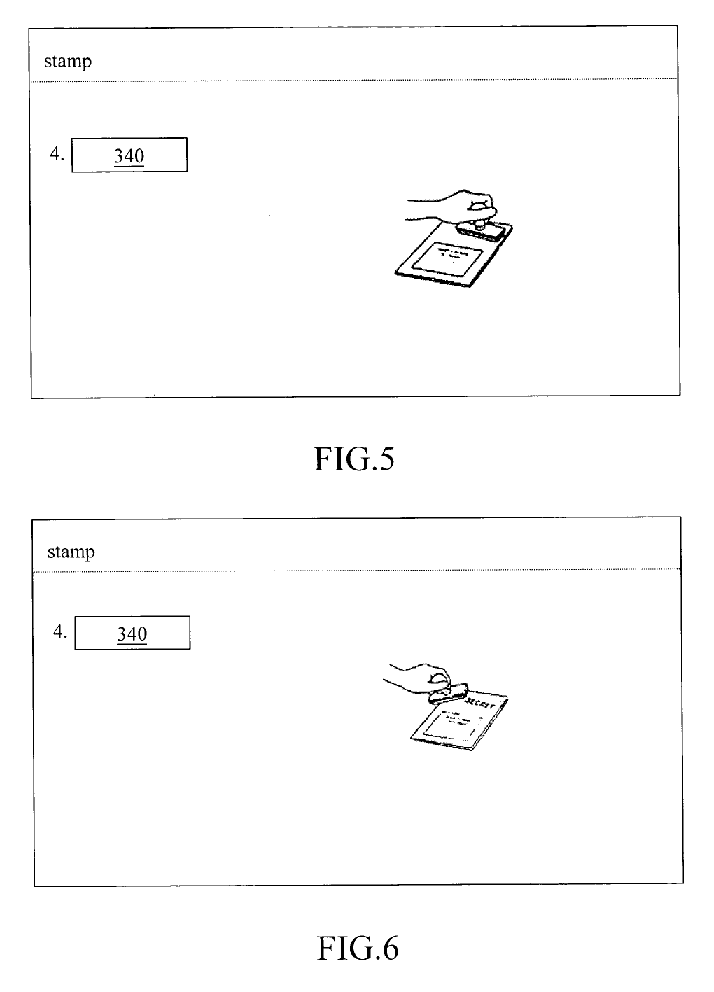

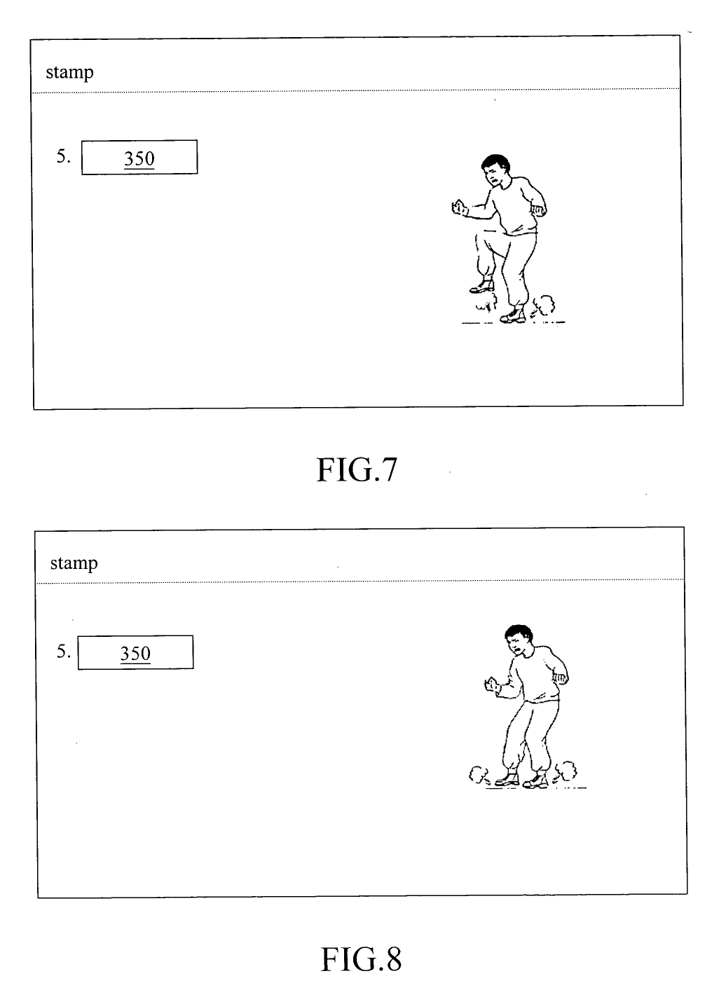

The operations of all units are as follows. First, the user enters a keyword to look up via the input unit 110. The CPU 130 receives the keyword look-up command and looks up the database 120. The system lists an index of words and phrases related to the keyword. The inquiry result is then displayed by the display unit 150, as shown in FIG. 3. The user selects one word, phrase or sentence to understand and the system displays the text explanations, as shown in FIG. 4. After displaying the text explanations, the user can further send a multimedia playing command by pressing a multimedia explanation playing button, as indicated by the “≃” buttons. We assume that the user presses the “≃” button after the fourth word. Once the CPU 130 receives the multimedia playing command, the multimedia explanations are extracted from the database 120 according to the multimedia playing command and the multimedia explanation index information. The extracted multimedia explanations are read by the multimedia player 140 and displayed via the display unit 150, as shown in FIGS. 5 and 6, to show the text explanation of the fourth word. Of course, if the user presses the “≃” button after the text explanation of the fifth word, then the corresponding multimedia explanation information is played as in FIGS. 7 and 8.

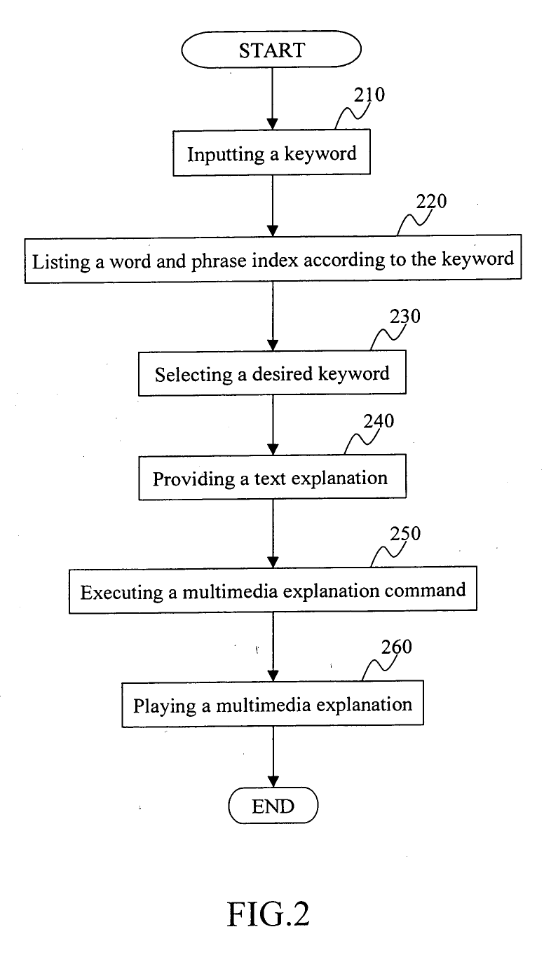

After explaining the data transmissions among the units of the disclosed system, we use FIG. 2 to illustrate the operational procedure of the disclosed method. First, the user has to input a keyword via the input unit 110 (step 210) to look up the word. Before looking up the keyword, the electronic dictionary looks for the close words or phrases in the database 120 to form an index according to each letter the user enters. Thus, an index containing the keyword is formed in step 220 (as shown in FIG. 3).

Once the index containing the keyword is displayed (step 220), the user can select a desired one (step 230). After the selection, the system extracts the corresponding text explanations of the chosen word from the database 120 and gives them to the display unit 150 for display (step 240), as shown in FIG. 4. If the user is not clear with any of the text explanations, he or she can press the “example” button of the text explanations to display example: sentence information. Moreover, the user can press the multimedia explanation playing button to send a multimedia explanation playing command (step 250). The system then plays the multimedia explanations (step 260) according to the command.

When the keyword explanation information selected by the user is its usage information, the played contents are the usage of the related words and phrases. For example, the usage of the prepositions: on, in, at, up, down, etc are illustrated in terms of their spatial positions and relations in the multimedia explanation information.

Certain variations would be apparent to those skilled in the art, which variations are considered within the spirit and scope of the claimed invention.

What is claimed is:

1. A system for playing vocabulary explanations using multimedia data comprising:
an input unit, which allows the input of a keyword;
a database, which stores text explanations, multimedia explanation index, and multimedia explanations;
a central processing unit (CPU), which is connected to the input unit and the database for receiving the inquiry command of the keyword, providing the text explanation, and providing the multimedia explanation according to the multimedia explanation index;
a multimedia player, which is connected to the CPU for playing the multimedia explanations; and
a display unit, which is connected to the CPU for displaying the text explanations and the multimedia explanations.

2. The system of claim 1, wherein the system is implemented on an electronic dictionary.

3. The system of claim 1, wherein the keyword is selected from the group consisting of a single word, a phrase, and a sentence.

4. The system of claim 1, wherein the text explanation comprises the combinations of explanation information, related keyword information, example sentence information, grammar information, and usage information.

5. The system of claim 1, wherein the multimedia explanation comprises the combinations of text information, picture information, sound information, music information, animation information, and video information.

6. The system of claim 1, wherein a multimedia explanation playing button is provided on a touch-control screen to trigger the playing of multimedia explanations.

7. The system of claim 1, wherein a multimedia explanation playing button is provided on a keyboard to trigger the playing of multimedia explanations.

8. A method for playing vocabulary explanations using multimedia data comprising the steps of:
inputting a keyword;
listing a word and phrase index according to the keyword;
selecting a desired keyword from the word and phrase index;
providing a text explanation and a multimedia explanation index for the desired keyword; and
playing a multimedia explanation according to the multimedia explanation index.

9. The method of claim 8, wherein the method is implemented on an electronic dictionary.

10. The method of claim 8, wherein the keyword is selected from the group consisting of a single word, a phrase, and a sentence.

11. The method of claim 8, wherein the text explanation comprises the combinations of explanation information, related keyword information, example sentence information, grammar information, and usage information.

12. The method of claim 8, wherein the multimedia explanation comprises the combinations of text information, picture information, sound information, music information, animation information, and video information.

13. The method of claim 8, wherein a multimedia explanation playing button is provided on a touch-control screen to trigger the playing of multimedia explanations.

14. The method of claim 8, wherein a multimedia explanation playing button is provided on a keyboard to trigger the playing of multimedia explanations.
